(19) United States
(12) Patent Application Publication
(10) Pub. No.: US 2021/0404985 A1
(43) Pub. Date: Dec. 30, 2021

(54) GAS SENSOR AND MANUFACTURING METHOD FOR GAS SENSOR

(71) Applicant: DENSO CORPORATION, Kariya-city (JP)

(72) Inventors: Kazutoshi KODAMA, Kariya-city (JP); Masato OZAWA, Kariya-city (JP); Shota HAGINO, Nisshin-city (JP)

(21) Appl. No.: 17/473,246

(22) Filed: Sep. 13, 2021

Related U.S. Application Data
(63) Continuation of application No. PCT/JP2020/010841, filed on Mar. 12, 2020.

(30) Foreign Application Priority Data
Mar. 14, 2019 (JP) 2019-047353

(51) Int. Cl. G01N 27/407; G01N 27/409; G01N 27/406

(52) U.S. Cl. CPC G01N 27/4078; G01N 27/4067; G01N 27/409

(57) ABSTRACT

In a gas sensor, a housing is formed into a cylindrical shape. A holding portion is arranged inside the housing and is formed into a cylindrical shape that has a through hole that passes through in an axial direction, when a direction in which an axis of the housing extends is the axial direction. A sensor element is formed to extend in the axial direction in a state where the sensor element passes through the through hole in the holding portion and detects a gas to be measured on one side in the axial direction. A glass seal is arranged inside the holding portion, is made of a glass material, and seals between the sensor element and the holding portion. A shock mitigating portion that mitigates shock being transferred from outside the housing through the holding portion to the glass seal is housed between the housing and the holding portion.

### CROSS-REFERENCE TO RELATED APPLICATION

The present application is a continuation application of International Application No. PCT/JP2020/010841, filed on Mar. 12, 2020, which claims priority to Japanese Patent Application No. 2019-047353, filed on Mar. 14, 2019. The contents of these applications are incorporated herein by reference in their entirety.

### BACKGROUND

### Technical Field

The present disclosure relates to a gas sensor and a manufacturing method for a gas sensor.

### Related Art

A gas sensor is used to detect a concentration of a specific gas in an exhaust gas that is discharged from an engine of an automobile. This gas sensor includes a cylindrical housing that is made of metal, a sensor element that is formed so as to extend along an axis of the housing in a state in which the sensor element passes through a through hole in a bottom portion of the housing, and a seal portion that seals between the sensor element and an inner circumferential surface of the housing.

### SUMMARY

One aspect of the present disclosure provides a gas sensor that includes a housing, a holding portion, a sensor element, a glass seal, and a shock mitigating portion. The housing has a cylindrical shape. The holding portion is arranged inside the housing and has a cylindrical shape that has a through hole that passes through in an axial direction, when a direction in which an axis of the housing extends is the axial direction. The sensor element is formed so as to extend in the axial direction in a state in which the sensor element passes through the through hole in the holding portion and detects a gas to be measured on one side in the axial direction; and a glass seal that is arranged inside the holding portion, is made of a glass material, and seals between the sensor element and the holding portion. The shock mitigating portion is housed between the housing and the holding portion and mitigates shock being transferred from outside the housing through the holding portion to the glass seal.

### BRIEF DESCRIPTION OF THE DRAWINGS

In the accompanying drawings:

FIG. 1 is a diagram of a cross-sectional configuration of an exhaust system of a gasoline engine of an automobile in which an air-fuel ratio (A/F) sensor according to a first embodiment is applied;

FIG. 2 is a cross-sectional view of the A/F sensor taken along a cross-section that includes an axis thereof, to show an internal configuration of the A/F sensor in FIG. 1;

FIG. 3 is a cross-sectional view of a sensor core of the A/F sensor according to the first embodiment taken along a cross-section that includes an axis thereof, the sensor core including a main fitting, a holding fitting, a glass seal, and a sensor element;

FIG. 4 is a perspective view of the sensor element of the A/F sensor in FIG. 1;

FIG. 5 is a flowchart of details of a manufacturing process for the A/F sensor according to the first embodiment;

FIG. 6 is a diagram for supplementing a description of a manufacturing process for a sensor core of the A/F sensor in FIG. 1, and is cross-sectional view of a state in which an alumina slurry for fixing the sensor element is applied before the glass seal is formed;

FIG. 7 is a diagram of an internal configuration of a sensor core of an A/F sensor according to a second embodiment and is a cross-sectional view of the sensor core taken along a cross-section that includes an axis thereof;

FIG. 8 is a diagram of an internal configuration of a sensor core of an A/F sensor according to a third embodiment and is a cross-sectional view of the sensor core taken along a cross-section that includes an axis thereof;

FIG. 9 is a diagram of an internal configuration of a sensor core of an A/F sensor according to a fourth embodiment and is a cross-sectional view of the sensor core taken along a cross-section that includes an axis thereof;

FIG. 10 is a diagram of an internal configuration of a sensor core of an A/F sensor according to a fifth embodiment and is a cross-sectional view of the sensor core taken along a cross-section that includes an axis thereof;

FIG. 11 is a diagram for supplementing a description of a manufacturing process for the A/F sensor in FIG. 10, and is cross-sectional view of a state in which an alumina slurry for fixing the sensor element is applied before a glass seal is formed;

FIG. 12 is a perspective view of a sensor element of an A/F sensor according to another embodiment; and

FIG. 13 is a perspective view of a sensor element of an A/F sensor according to another embodiment.

### DESCRIPTION OF THE EMBODIMENTS

Conventionally, a gas sensor is used to detect a concentration of a specific gas in an exhaust gas that is discharged from an engine of an automobile.

The gas sensor includes a cylindrical housing that is made of metal, a sensor element that is formed so as to extend along an axis of the housing in a state in which the sensor element passes through a through hole in a bottom portion of the housing, and a seal portion that seals between the sensor element and an inner circumferential surface of the housing.

Airtightness between the sensor element and the housing is ensured by the seal portion. Therefore, a gas to be measured, such as the exhaust gas, that is introduced on a tip end side of the sensor element is prevented from infiltrating a rear end side of the sensor element.

In a structure in which the seal portion of the gas sensor such as this is made of talc, sufficient airtightness is even maintained in cases in which the gas sensor is arranged in an environment that is about 600° C. However, in recent years, a tendency towards a rich state regarding an air-fuel ratio has been shifting towards reduction (that is, a tendency towards a lean state) in accompaniment with improvement in engine emissions, and an environmental temperature of the gas sensor has become higher than in the past.

In a high-temperature environment such as this, sufficient airtightness cannot be ensured in the structure in which the seal portion is made of talc. Therefore, a gas sensor that is provided with a glass seal in which glass is used to seal between the housing and the sensor element has been receiving attention (for example, refer to JP-A-2016-099184).

However, based on studies by the inventors, in a gas sensor of JP-A-2016-099184, described above, an outer wall of the housing is exposed on an outer side of a vehicle. When a flying stone or the like directly strikes the housing from outside, shock thereof is transferred to the glass seal itself inside the housing. Therefore, the glass seal may crack as a result of the shock, and airtightness between the housing and the sensor element may be compromised.

It is thus desired to provide a gas sensor that mitigates shock from outside a housing being transferred to a glass seal, and a manufacturing method that is suitable for the gas sensor.

A first exemplary embodiment of the present disclosure provides a gas sensor that includes: a housing that has a cylindrical shape, a holding portion that is arranged inside the housing and has a cylindrical shape that has a through hole that passes through in an axial direction, when a direction in which an axis of the housing extends is the axial direction; a sensor element that is formed so as to extend in the axial direction in a state in which the sensor element passes through the through hole in the holding portion and detects a gas to be measured on one side in the axial direction; and a glass seal that is arranged inside the holding portion, is made of a glass material, and seals between the sensor element and the holding portion. A shock mitigating portion that mitigates shock being transferred from outside the housing through the holding portion to the glass seal is housed between the housing and the holding portion.

Therefore, even when shock is transferred from outside the housing, the shock is not easily transferred through the holding portion to the glass seal. Consequently, a gas sensor in which shock from outside a housing being transferred to a glass seal is mitigated can be provided.

A second exemplary embodiment of the present disclosure provides a manufacturing method for a gas sensor that includes: preparing a housing that has a cylindrical shape, a holding portion that has a cylindrical shape, and a sensor element; forming a glass seal that seals between the holding portion and the sensor element in a state in which the sensor element passes through a through hole in the holding portion; and arranging the holding portion inside the housing, and fixing the housing and the holding portion in a state in which a bottom portion of the holding portion is arranged on one side in an axial direction of the housing and an opening portion of the holding portion is arranged on another side in the axial direction, and configuring, by the housing and the holding portion, a housing portion for housing a shock mitigating portion between the housing and the holding portion.

Consequently, a manufacturing method for a gas sensor in which shock from outside a housing being transferred to a glass seal is mitigated can be provided.

Reference numbers in parentheses that are attached to constituent elements and the like indicate examples of corresponding relationships between the constituent elements and the like and specific constituent elements and the like described according to embodiments described hereafter.

Embodiments of the present disclosure will hereinafter be described with reference to the drawings. Here, sections among the embodiments below that are identical or equivalent to each other are given the same reference numbers in the drawings to simplify the descriptions.

### First Embodiment

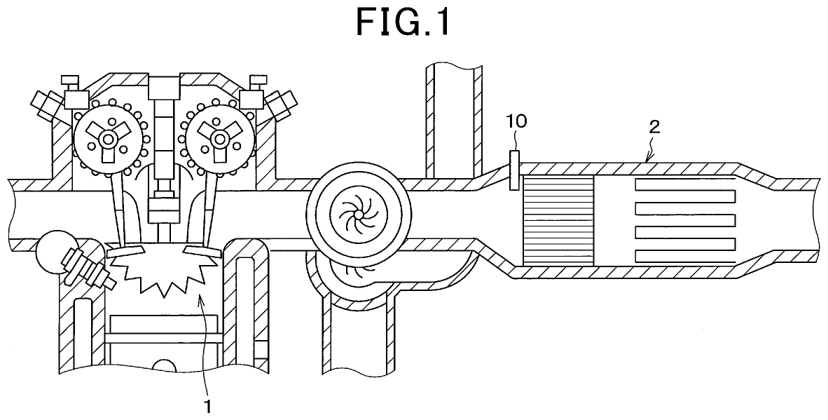

An air-fuel ratio (A/F) sensor according to a present first embodiment will be described with reference to FIG. 1 to FIG. 6. An A/F sensor 10 according to the present embodiment is a gas sensor that is arranged in an exhaust pipe 2 of a gasoline engine 1 for traveling of an automobile.

Specifically, one side in an axial direction of the A/F sensor 10 is arranged in the exhaust pipe 2. An outer wall on another side in the axial direction of the A/F sensor 10 is exposed outside a vehicle. The axial direction will be described hereafter.

The A/F sensor 10 outputs a detection signal that indicates a ratio of an oxygen concentration in an exhaust gas of the gas engine 1 that flows through the exhaust pipe 2 and an oxygen concentration in air outside the exhaust pipe 2 (that is, outside the vehicle). The detection signal of the A/F sensor 10 according to the present embodiment is used to control an air-fuel ratio of the gasoline engine 1.

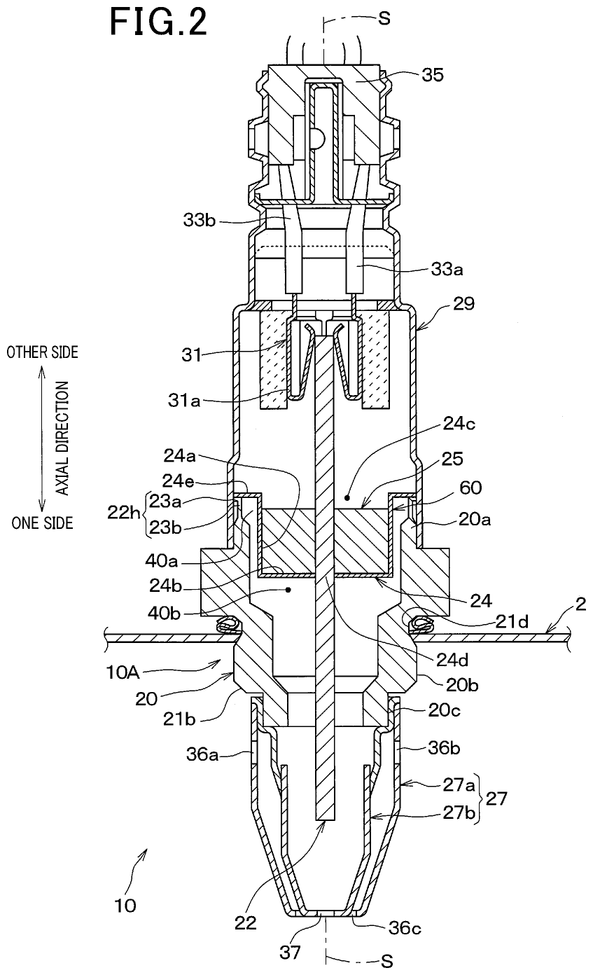

As shown in FIG. 2, the A/F sensor 10 includes a main fitting 20, a sensor element 22, a holding fitting 24, a glass seal 25, a lower cover portion 27, an upper cover portion 29, a contact member 31, lead portions 33a and 33b, and a lid portion 35.

The main fitting 20 is a housing that is formed into a circular cylindrical shape by a metal material. Hereafter, for convenience of description, a direction in which an axis S of the main fitting 20 extends is the axial direction. One side in the axial direction of the main fitting 20 is arranged inside the exhaust pipe 2. Another side in the axial direction of the main fitting 20 is arranged outside the exhaust pipe 2. Therefore, an outer wall on the other side in the axial direction of the main fitting 20 is exposed outside the vehicle.

The main fitting 20 according to the present embodiment includes cylindrical portions 20a, 20b, and 20c. The cylindrical portions 20a, 20b, and 20c are arranged such that respective axes coincide with the axis S. The cylindrical portion 20a is arranged on the other side in the axial direction relative to the cylindrical portion 20b.

The cylindrical portions 20a and 20b are connected. The cylindrical portion 20b is arranged on the other side in the axial direction relative to the cylindrical portion 20c. The cylindrical portions 20b and 20c are connected.

Here, an inner-diameter dimension Ra of the cylindrical portion 20a is greater than an inner-diameter dimension Rb (Rb<Ra) of the cylindrical portion 20b. The inner-diameter dimension Rb of the cylindrical portion 20b is greater than an inner-diameter dimension Rc (Rc<Rb) of the cylindrical portion 20c.

A recess portion 21d that is recessed towards an inner side in a radial direction centered on the axis S is formed on an outer circumferential surface of the cylindrical portion 20b of the main fitting 20. The recess portion 21d is formed over a circumferential direction centered on the axis S. The recess portion 21d is positioned inside a through hole 2a of the exhaust pipe 2.

A rib 22h is provided on the other side in the axial direction relative to the cylindrical portion 20a of the main fitting 20. The rib 22h includes a ring portion 23a and a protruding portion 23b. The ring portion 23a is formed so as to protrude towards the other side in the axial direction from the cylindrical portion 20a.

The ring portion 23a is formed over the circumferential direction centered on the axis S. The protruding portion 23b is formed so as to protrude towards an outer side in the radial direction centered on the axis S, from the other side in the axial direction of the ring portion 23a.

According to the present embodiment, a thickness dimension ra of the rib 22h is less than a thickness dimension rb (rb>ra) of the cylindrical portion 20a. The thickness dimension ra is a dimension in the radial direction centered on the axis S of the rib 22h. The thickness dimension rb is a dimension in the radial direction centered on the axis S of the cylindrical portion 20a.

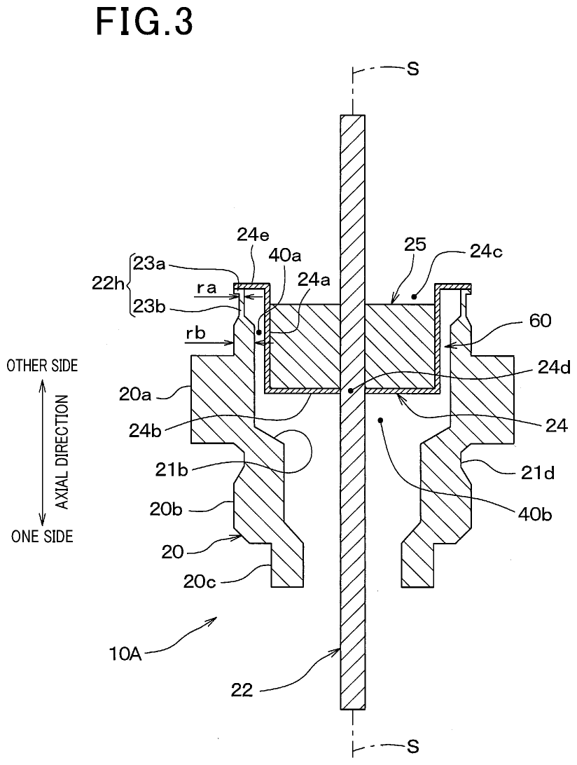

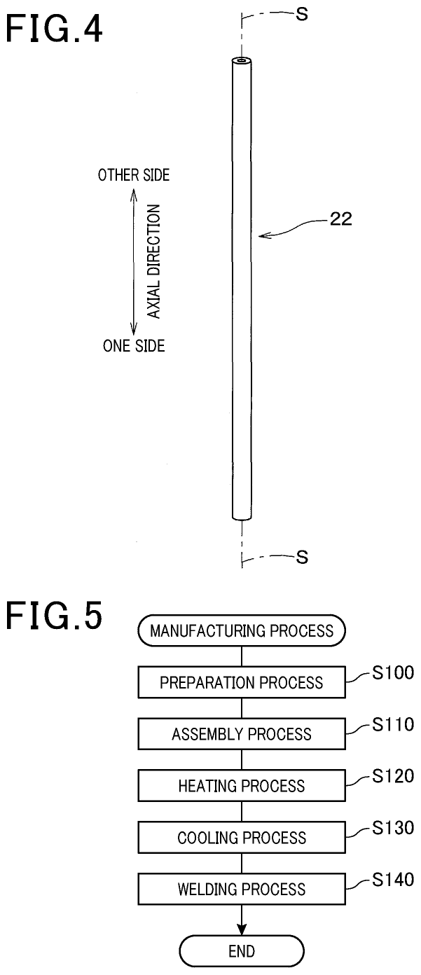

The sensor element 22 is arranged inside the main fitting. As shown in FIG. 3 and FIG. 4, the sensor element 22 is formed into a circular cylindrical shape that extends in the axial direction and in which opening portions are formed on one side in the axial direction and the other side in the axial direction. Specifically, the sensor element 22 is arranged such that an axis thereof coincides with the axis S of the main fitting 20.

One side in the axial direction of the sensor element 22 is positioned on one side in the axial direction relative to the main fitting 20. The other side in the axial direction of the sensor element 22 is positioned on the other side in the axial direction relative to the main fitting 20.

One side in the axial direction of the sensor element 22 is arranged inside the exhaust pipe 2. The other side in the axial direction of the sensor element 22 is arranged outside the exhaust pipe 2. The sensor element 22 is arranged inside the holding fitting 24 in a state in which the sensor element 22 passes through a through hole 24d in a bottom portion 24b of the holding fitting 24.

The sensor element 22 according to the present embodiment is a known sensor element that is configured by a sintered body, and outputs a detection signal that indicates a ratio of an oxygen concentration (hereafter, an exhaust-gas oxygen concentration) in the exhaust gas that flows through the exhaust pipe 2 and an oxygen concentration (hereafter, an outside-air oxygen concentration) in air outside the exhaust pipe 2.

Specifically, the sensor element 22 outputs a detection signal that indicates a ratio of the exhaust-gas oxygen concentration that is introduced from the opening portion on one side in the axial direction and the outside-air oxygen concentration that is introduced from the opening portion on the other side in the axial direction.

The holding fitting 24 is a holding portion that is formed into a circular cylindrical shape by a metal material. As shown in FIG. 3, the holding fitting 24 is arranged inside the main fitting 20. The holding fitting 24 is arranged such that an axis thereof coincides with the axis S of the main fitting 20.

Specifically, the holding fitting 24 is arranged inside the cylindrical portion 20a of the main fitting 20. As shown in FIG. 3, the holding fitting 24 includes a side wall 24a that is formed into a circular cylindrical shape. The side wall 24a is arranged such that an axis thereof coincides with the axis S of the main fitting 20. A space 40a is formed between the side wall 24a and an inner circumferential surface 21a of the cylindrical portion 20a.

A flange portion 24e that serves as a first protruding portion is provided in an end portion of the side wall 24a that is positioned on the other side in the axial direction. The flange portion 24e is formed into an annular shape centered on the axis S. The flange portion 24e is formed so as to protrude towards the outer side in the radial direction centered on the axis S (that is, the main fitting 20 side), from an end portion on the other side in the axial direction of a ring portion 24g.

An outer side in the radial direction of the flange portion 24e is positioned on the other side in the axial direction relative to the rib 22h of the main fitting 20. An outer side in the radial direction of the flange portion 24e and the rib 22h of the main fitting 20 are joined by welding over the circumferential direction centered on the axis S.

As a result, the space 40a is formed between an outer circumferential surface of the holding fitting 24 and an inner circumferential surface of the main fitting 20. The bottom portion 24b is formed on one side in the axial direction of the side wall 24a. A through hole 24d that passes through in the axial direction is formed in the bottom portion 24b.

The bottom portion 24b is formed so as to spread in the radial direction centered on the axis S. A space 40b is formed between the bottom portion 24b of the holding fitting 24 and an axial-direction other-side end portion 21b of the cylindrical portion 20b of the main fitting 20.

According to the present embodiment, for example, a ferritic stainless steel, such as SUS430, or the like is used as the main fitting 20. For example, alumina, Kovar, or the like is used as the holding fitting 24.

A coefficient of linear expansion CTE2 of the holding fitting 24 is less than a coefficient of linear expansion CTE1 of the main fitting 20. A coefficient of linear expansion CTE3 of the glass seal 25 is less than the coefficient of linear expansion CTE2 of the holding fitting 24.

That is, the coefficient of linear expansion CTE1 of the main fitting 20, the coefficient of linear expansion CTE2 of the holding fitting 24, and the coefficient of linear expansion CTE3 of the glass seal 25 have a relationship that satisfies CTE1>CTE2>CTE3.

Here, the spaces 40a and 40b configure a housing portion 60 that houses air that serves as a shock mitigating portion, described hereafter. That is, the holding fitting 24 and the main fitting 20 form the spaces 40a and 40b that serve as a housing portion between the holding fitting 24 and the main fitting 20. An opening portion 24c that opens on the other side in the axial direction is formed on the other side in the axial direction of the side wall 24a of the main fitting 20.

According to the present embodiment, a thermal conductivity tc1A of air that serves as the shock mitigating portion and a first shock mitigating portion is less than a thermal conductivity tc2 (tc2>tc1A) of the main fitting 20, and less than a thermal conductivity tc3 (tc3>tc1A) of the holding fitting 24.

The glass seal 25 is arranged inside the holding fitting 24. The glass seal 25 seals between the side wall 24a and the bottom portion 24b of the holding fitting 24, and the sensor element 22. That is, the glass seal 25 seals between the holding fitting 24 and the sensor element 22. The glass seal 25 according to the present embodiment is formed by a single-layer glass seal.

For convenience of description, a core portion of the A/F sensor 10 that is configured by the main fitting 20, the sensor element 22, the holding fitting 24, and the glass seal 25 in this manner is referred to, hereafter, as a sensor core 10A.

The lower cover portion 27 is configured to have a double structure that includes an outer cover portion 27a and an inner cover portion 27b. The outer cover portion 27a is formed into a cylindrical shape centered on the axis S. The inner cover portion 27b is formed into a cylindrical shape centered on the axis S.

The inner cover portion 27b is formed so as to surround one side in the axial direction of the sensor element 22 from the outer side in the radial direction. The outer cover portion 27a is arranged on the outer side in the radial direction centered on the axis S relative to the inner cover portion 27.

The other side in the axial direction of the outer cover portion 27a is formed so as to surround the cylindrical portion 20c of the main fitting 20 from the outer side in the radial direction centered on the axis S. The outer cover portion 27a and the cylindrical portion 20c of the main fitting 20 are joined by welding. The other side in the axial direction of the outer cover portion 27a is supported by an axial-direction other-side end portion 21c of the cylindrical portion 20b.

Hole portions 36a, 36b, and 36c are formed in the outer cover portion 27a. The hole portions 36a and 36b pass through between an outer side and an inner side of the outer cover portion 27a in the radial direction centered on the axis S. The hole portion 36c passes through between the outer side and the inner side of the outer cover portion 27a in the axial direction.

The inner cover portion 27b is arranged on one side in the axial direction relative to the cylindrical portion 20c of the main fitting 20. A hole portion 37 is formed in the inner cover portion 27b.

The hole portion 37 passes through between an outer side and an inner side of the inner cover portion 37 in the axial direction. The hole portion 37 is arranged in the hole portion 36c of the outer cover portion 27a. The hole portions 36a and 36b of the outer cover portion 27a are positioned on the other side in the axial direction relative to the hole portion 37 of the inner cover portion 27b.

The hole portions 36a, 36b, and 36c of the outer cover portion 27a and the hole portion 37 of the inner cover portion 27b form a gas flow path that leads the exhaust gas that flows through the exhaust pipe 2 to the sensor element 22.

The outer cover portion 27a and the inner cover portion 27b according to the present embodiment suppress, in advance, water and the like that is discharged from the gasoline engine 1 from directly coming into contact with one side in the axial direction of the sensor element 22.

The upper cover portion 29 is arranged on the other side in the axial direction relative to the cylindrical portion 20a of the main fitting 20 and the holding fitting 24. The upper cover portion 29 is formed into a circular cylindrical shape centered on the axis S.

One side in the axial direction of the upper cover portion 29 is formed so as to cover the cylindrical portion 20a of the main fitting 20 from the outer side in the radial direction centered on the axis S. The upper cover portion 29 and the cylindrical portion 20a of the main fitting 20 are joined by welding or the like.

The upper cover portion 29 according to the present embodiment is formed so as to surround the other side in the axial direction of the sensor element 22 from the outer side in the radial direction centered on the axis S.

The contact member 31 is arranged inside the upper cover portion 29. A sensor holding portion 31a for holding the sensor element 22 by elastic force is provided on one side in the axial direction of the contact member 31. The sensor holding portion 31a serves to hold the other side in the axial direction of the sensor element 22 in a state of being in contact with a positive electrode terminal and a negative electrode terminal of the sensor element 22.

Respective one end sides of the lead portions 33a and 33b are connected to the contact member 31. The lead portions 33a and 33b each pass through the lid portion 35 and extend outside the A/F sensor 10.

The contact member 31 and the lead portions 33a and 33b configure a signal transmission path over which a detection signal that is outputted from the sensor element 22 is transmitted to an electronic control apparatus that is arranged outside the A/F sensor 10. The lid 35 serves to close an opening portion on the other side in the axial direction of the upper cover portion 29.

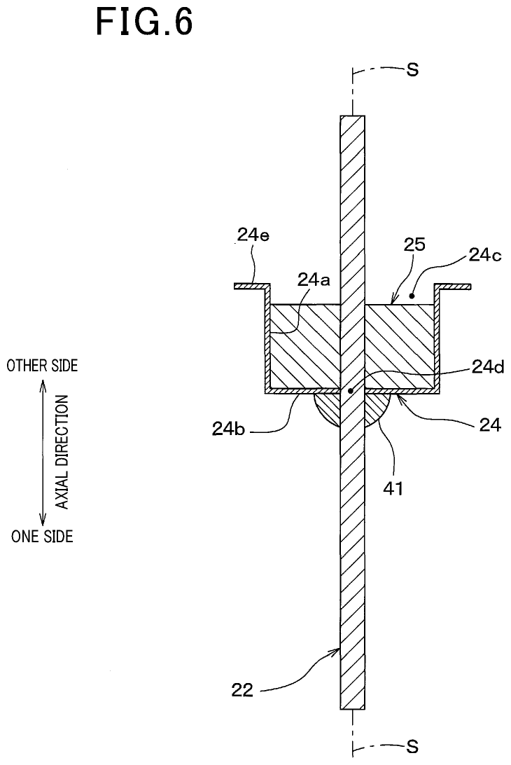

Next, a manufacturing method for the sensor core 10A of the A/F sensor 10 according to the present embodiment will be described with reference to FIG. 5 and FIG. 6.

In a first process (step S100), the main fitting 20, the sensor element 22, the holding fitting 24, and a pellet-shaped glass material are independently prepared. The glass material is a raw material for the glass seal 25 and is made of pellet-shaped glass.

In a next second process (step S110), the glass material is placed in the holding fitting 24 in a state in which the sensor element 22 passes through the through hole 24 in the bottom portion 24b of the holding fitting 24.

Here, an alumina slurry for determining a position of the sensor element 22 relative to the bottom portion 24b of the holding fitting 24 is prepared. The alumina slurry is a raw material for a ceramic of which a main ingredient is alumina powder.

Specifically, the alumina slurry is a paste material that contains a powder (or granules) made of alumina and a binder in a solvent, and has fluidity. The binder refers to a powder (or granules) that is made of a resin material that is used to bring alumina particles closer together.

As the resin material that composes the binder according to the present embodiment, a resin such as a thermoplastic resin or a thermally solidified resin is used.

In addition, as shown in FIG. 6, the alumina slurry 41 is applied to an outer side of the bottom portion 24b of the holding fitting 24. The alumina slurry is arranged so as to connect the outer side of the bottom portion 24b of the holding fitting 24 and the sensor element 22. The alumina slurry 41 is formed over the circumferential direction so as to surround an outer circumference of the sensor element 22.

Subsequently, in a next third process (step S120), the sensor element 22, the holding fitting 24, the glass material, and the alumina slurry 41 are placed in a high-temperature furnace, and the sensor element 22, the holding fitting 24, the glass material, and the alumina slurry 41 are heated.

At this time, the alumina slurry 41 is fired and a sintered body of alumina is formed. The sintered body determines the position of the sensor element 22 relative to the bottom portion 24b of the holding fitting 24. Therefore, the glass material is heated and melted inside the holding fitting 24 in a state in which the sintered body determines the position of the sensor element 22 relative to the bottom portion 24b of the holding fitting 24.

Here, an interior of the high-temperature furnace filled with ambient gas when the sensor element 22, the holding fitting 24, the glass material, and the alumina slurry 41 are heated. As the ambient gas, an ambient gas that suppresses progression of an oxidation reaction of the holding fitting 24, such as argon gas (that is, a non-oxidizing gas) that serves as an inert gas can be used.

Therefore, as a result of an interior of the holding fitting 24 and a periphery of the holding fitting 24 being filled with the ambient gas, the glass material and the alumina slurry 41 inside the holding fitting 24 are heated in a state in which air (that is, oxygen) is removed from the interior of the holding fitting 24 and the periphery of the holding fitting 24.

In a next fourth process (step S130), the sensor element 22, the holding fitting 24, the glass material, and the like are cooled. Therefore, the glass material inside the holding fitting 24 is crystalized and solidified. As a result, the glass material is joined to the sensor element 22 and also joined to the holding fitting 24.

Consequently, the glass seal 25 is formed between the holding fitting 24 and the sensor element 22 in a state in which the sensor element 22 passes through the through hole 24d in the bottom portion 24b of the holding fitting 24.

As a result, the glass seal 25 can be formed in a state in which the position of the sensor element 22 relative to the holding fitting 24 is determined. Therefore, the glass seal 25 seals between the holding fitting 24 and the sensor element 22.

Subsequently, in the next fifth process (step S140), the sensor element 22, the holding fitting 24, and the glass seal 25 are housed inside the main fitting 20. In addition, the flange portion 24e of the holding fitting 24 is joined to the end portion on the other side in the axial direction of the main fitting 20 by being welded along the circumferential direction.

As a result, the housing portion 60 is formed by the holding fitting 24 and the main fitting 20.

As a result of the foregoing, the sensor core 10A in which the main fitting 20, the sensor element 22, the holding fitting 24, and the glass seal 25 are integrated is completed.

Next, operations of the A/F sensor 10 according to the present embodiment will be described.

First, the exhaust gas in the exhaust pipe 2 is led inside the inner cover portion 27b through the hole portions 36a and 36b of the outer cover portion 27a and the hole portion (not shown) of the inner cover portion 27b. The exhaust gas in the exhaust pipe 2 is lead inside the inner cover portion 27b through the hole portion 37 of the inner cover portion 27b.

The exhaust gas that is led inside the inner cover portion 27b in this manner comes into contact with one side in the axial direction of the sensor element 22. The other side in the axial direction of the sensor element 22 is arranged outside the exhaust pipe 2. The other side in the axial direction of the sensor element 22 is in contact with the air outside the exhaust pipe 2. The one side in the axial direction of the sensor element 22 and the other side in the axial direction of the sensor element 22 are separated by the glass seal 25.

Therefore, the sensor element 22 outputs a detection signal that indicates the ratio of the oxygen concentration in the exhaust gas inside the exhaust pipe 2 and the oxygen concentration in the air outside the exhaust pipe 2. The detection signal is transmitted to the electronic control apparatus through the contact member 31 and the lead portions 33a and 33b.

According to the present embodiment described above, the A/F sensor 10 includes the main fitting 20 that is formed into a cylindrical shape and the holding fitting 24 that is formed into a cylindrical shape. When the direction in which the axis S of the main fitting 20 extends is the axial direction, the holding fitting 24 is arranged inside the main fitting 20, has the bottom portion 24b that is arranged on one side in the axial direction, and forms the opening portion 24c on the other side in the axial direction.

The A/F sensor 10 includes the sensor element 22 that is formed so as to extend in the axial direction in a state in which the sensor element 22 passes through the through hole 24d in the bottom portion 24b of the holding fitting 24, and detects the gas to be measured on one side in the axial direction.

The A/F sensor 10 includes the glass seal 25 that is arranged inside the holding fitting 24, is made of glass, and seals between the sensor element 22 and the holding fitting 24.

The main fitting 20 and the holding fitting 24 configure the housing portion 60 that houses air (that is, the shock mitigating portion) that mitigates shock being transferred from outside the main fitting 20 through the holding fitting 24 to the glass seal 25, between the main fitting 20 and the holding fitting 24.

As a result of the foregoing, even when shock is transferred from outside the main fitting 20, the shock is not easily transferred through the holding fitting 24 to the glass seal 25. Therefore, shock being transferred from outside the main fitting 20 to the glass seal 25 can be mitigated.

Consequently, the A/F sensor 10 that is configured to prevent the glass seal 25 from breaking as a result of shock in advance and a manufacturing method that is suitable for the A/F sensor 10 can be provided.

According to the present embodiment, the thickness dimension ra of the rib 22h is less than the thickness dimension rb (rb>ra) of the cylindrical portion 20a. Therefore, the rib 22h less easily transfers heat compared to the cylindrical portion 20a.

As a result, when the main fitting 20 is rapidly cooled by water or the like, heat is not easily transferred from the glass seal 25 through the holding fitting 24 to the main fitting 20. Consequently, even when the main fitting 10 receives thermal shock that is attributed to water or the like from outside, breakage of the glass seal 25 can be suppressed in advance.

According to the present embodiment, the coefficient of linear expansion CTE1 of the main fitting 20, the coefficient of linear expansion CTE2 of the holding fitting 24, and the coefficient of linear expansion CTE3 of the glass seal 25 have the relationship that satisfies the coefficient of linear expansion CTE1>the coefficient of linear expansion CTE2>the coefficient of linear expansion CTE3. Therefore, the holding fitting 24 is capable of absorbing force that is applied to the glass seal 25 from the main fitting 20 as a result of thermal expansion of the main fitting 20. Consequently, the glass seal 25 cracking as a result of thermal expansion of the main fitting 20 can be suppressed in advance.

Here, a linear expansion difference (=CTE1−CTE2) that is a difference between the coefficient of linear expansion CTE1 of the main fitting 20 and the coefficient of linear expansion CTE2 of the holding fitting 24 is preferably equal to or less than 6×10⁻⁶/° C. This difference in linear expansion is a difference in coefficient of expansion. As a result, the holding fitting 24 is capable of absorbing force that is applied to the glass seal 25 side from the main fitting 20 as a result of thermal expansion of the main fitting 20. Consequently, breakage of the glass seal 25 as a result of the force that is applied to the glass seal 25 from the main fitting 20 as a result of thermal expansion of the main fitting 20 can be prevented in advance.

In addition, in a conventional A/F sensor that is not provided with a shock mitigating portion, when water that is churned up from a puddle by a tire of an automobile splashes onto the main fitting 20 and the main fitting 20 is rapidly cooled, heat from the glass seal 25 is rapidly transferred to the main fitting 20. Therefore, thermal contraction may occur in the glass seal 25, the glass seal 25 may break, and airtightness between the holding fitting 24 and the sensor element 22 may be compromised.

In contrast, the thermal conductivity tc1A of air that serves as the shock mitigating portion according to the present embodiment is less than the thermal conductivity tc2 (tc2>tc1A) of the main fitting 20, and less than the thermal conductivity tc3 (tc3>tc1A) of the holding fitting 24.

Here, an environmental temperature of the A/F sensor 10 is high as described above. Therefore, a temperature of the glass seal 25 is also high. Here, even when water that is churned up from a puddle by a tire of an automobile splashes onto the main fitting 20 and the main fitting 20 is rapidly cooled, heat from the glass seal 25 can be suppressed from being transferred through the holding fitting 24 to the main fitting 20 by the air that serves as the shock mitigating portion.

As a result, cracking of the glass seal 25 as a result of rapid cooling of the main fitting 20 can be suppressed in advance. That is, the glass seal cracking as a result of thermal shock attributed to water that is splashed onto the main fitting 20 and airtightness being lost compromised can be suppressed in advance.

According to the present embodiment, the glass material inside the holding fitting 24 is heated in a state in which the interior of the holding fitting 24 and the periphery of the holding fitting 24 are filled with the ambient gas. Therefore, oxides being formed in the holding fitting 24 in accompaniment with heating of the glass material can be suppressed in advance.

According to the present embodiment, the main fitting 20 and the holding fitting 24 are welded in a state in which a periphery of a welding site of the main fitting 20 and the holding fitting 24 is filled with the ambient gas to suppress oxidation reaction at the welding site. As a result, because oxidation reaction at the welding site of the main fitting 20 and the holding fitting 24 can be prevented, joining strength of the main fitting 20 and the holding fitting 24 can be ensured.

According to the present embodiment, the cylindrical shape is formed in which the bottom portion 24b is provided on one side in the axial direction of the holding fitting 24 and the opening portion 24c is formed on the other side in the axial direction. The through hole 24c through which the sensor element 22 passes is provided in the bottom portion 24b. Therefore, the holding fitting 24 can easily house the glass seal 25.

### Second Embodiment

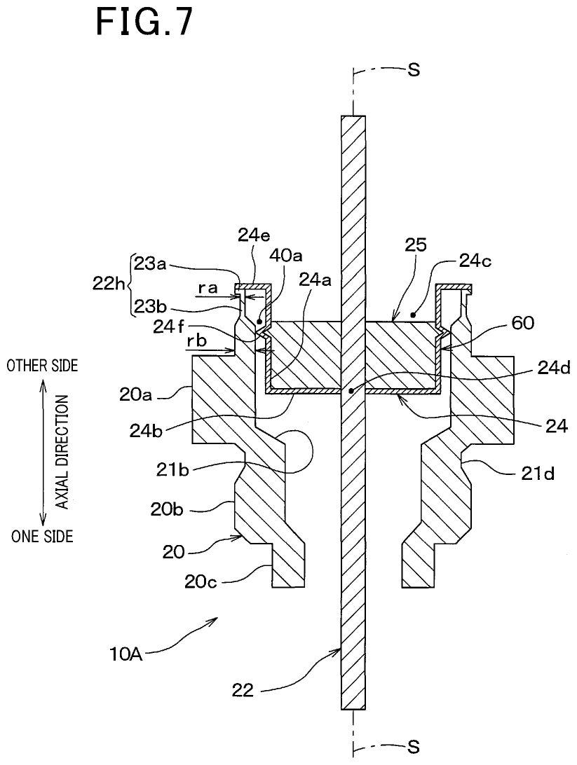

In the A/F sensor 10 according to the above-described first embodiment, an example in which the flange portion 24e of the holding fitting 24 is joined to the main fitting 20 is described. However, a present second embodiment in which a rib 24f of the holding fitting 24 is joined to the main fitting 20 in addition to the foregoing will be described with reference to FIG. 7.

As shown in FIG. 7, the A/F sensor 10 according to the present second embodiment is configured such that the rib 24f is added to the A/F sensor 10 according to the above-described first embodiment. In FIG. 7, reference numbers that are the same as those according to FIG. 2 and FIG. 3 indicate same parts. Descriptions thereof are omitted.

The rib 24f configures a second protruding portion that protrudes towards the outer side in the radial direction centered on the axis S (that is, the main fitting 20 side) from the side wall 24a of the holding fitting 24. Specifically, the rib 24f is formed such by an outer surface of the holding fitting 24 protruding towards the outer side in the radial direction and an inner surface of the holding fitting 24 protruding towards the outer side in the radial direction.

The rib 24f is formed over the circumferential direction centered on the axis S. The rib 24f is formed such that a cross-sectional area decreases towards the outer side in the radial direction centered on the axis S. A cross-section of the rib 24f is a cross-section in which the rib 24f is cut in parallel with the axial direction.

The rib 24f is arranged on one side in the axial direction relative to the flange portion 24e. A tip end portion on the outer side in the radial direction of the rib 24f is joined to the inner circumferential surface of the main fitting 20 by welding over the circumferential direction.

Consequently, as a result of the holding fitting 24 being joined to the main fitting 20 by the tip end side of the rib 24f and the tip end side of the flange portion 24e, the housing portion 60 is formed by the holding fitting 24 and the main fitting 20.

Here, the glass seal 25 is arranged on an inner side of the rib 24f of the holding fitting 24 as well.

According to the present embodiment described above, the holding fitting 24 of the A/F sensor 10 is arranged inside the main fitting 20, has the bottom portion 24b that is arranged on one side in the axial direction, and forms the opening portion 24c on the other side in the axial direction.

The A/F sensor 10 includes the sensor element 22 that detects the gas to be measured on the one side in the axial direction in a state in which the sensor element 22 passes through the through hole 24d in the bottom portion 4b of the holding fitting 24. The A/F sensor 10 includes the glass seal 25 that is arranged inside the holding fitting 24 and seals between the sensor element 22 and the holding fitting 24 by a glass material.

The main fitting 20 and the holding fitting 24 configure the housing portion 60 that houses that mitigates shock being transferred from outside the main fitting 20 through the holding fitting 24 to the glass seal 25, between the main fitting 20 and the holding fitting 24.

As a result of the foregoing, in a manner similar to that according to the above-described first embodiment, even when shock is transferred from outside the main fitting 20, the shock is not easily transferred through the holding fitting 24 to the glass seal 25. Therefore, the A/F sensor 10 in which shock being transferred from outside the main fitting 20 to the glass seal 25 is mitigated can be provided.

The holding fitting 24 according to the present embodiment is joined to the main fitting 20 by the rib 24f and the flange portion 24e. Therefore, strength of joining between the holding fitting 24 and the main fitting 20 can be increased. As a result, the spaces 40a and 40b (that is, the housing portion 60) can be reliably ensured between the main fitting 20 and the holding fitting 24.

The holding fitting 24 according to the present embodiment is formed such that the cross-sectional area of the rib 24f decreases towards the outer side in the radial direction centered on the axis S. Therefore, when shock from outside the main fitting 20 is transferred to the rib 24f, a portion of the shock is dispersed to one side and the other side in the axial direction by the rib 24f.

As a result, the shock that is transferred from outside the main fitting 20 through the holding fitting 24 to the glass seal 25 can be reduced.

### Third Embodiment

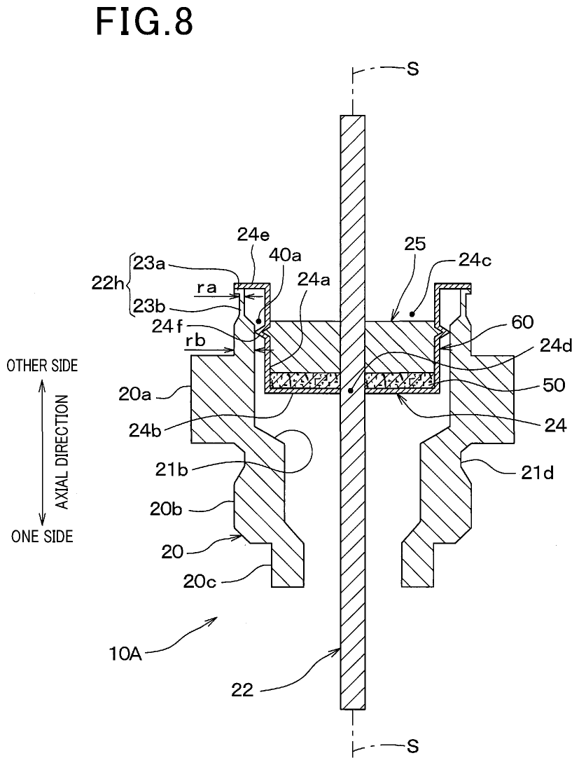

In the A/F sensor 10 according to the above-described second embodiment, an example in which the glass seal 25 is configured inside the holding fitting 24 is described. However, a present third embodiment in which a shock mitigating portion 50 is arranged between the bottom portion 24b and the glass seal 25 inside the holding fitting 24, in addition to the foregoing, will be described with reference to FIG. 8.

The A/F sensor 10 according to the present embodiment is the A/F sensor 10 according to the above-described second embodiment in which the shock mitigating portion 50 is added. Configurations of the A/F sensor 10 other than the shock mitigating portion 50 are identical. Reference numbers in FIG. 8 that are the same as those in FIG. 7 indicate the same parts. Descriptions thereof are omitted.

The shock mitigating portion 50 is a brittle portion that is arranged on one side in the axial direction relative to the glass seal 25 in the holding fitting 24. The shock mitigating portion 50 is a second shock mitigating portion that is arranged between the bottom portion 24b and the glass seal 25. As the shock mitigating portion 50, a brittle material that has brittleness that is more brittle than the glass seal 25 is used. For example, as the shock mitigating portion 50 according to the present embodiment, powdered talc that has been hardened is used.

As a result, when shock is applied from outside the bottom portion 24b, the shock mitigating portion 50 can make the shock less easily transferred to the glass seal 25 by absorbing the shock. Therefore, the glass seal 25 can be made less likely to crack as a result of shock.

According to the present embodiment described above, the main fitting 20 and the holding fitting 24 configure the housing portion 60 that houses air that mitigates shock being transferred from outside the main fitting 20 through the holding fitting 24 to the glass seal 25, between the main fitting 20 and the holding fitting 24.

Therefore, in a manner similar to that according to the above-described first embodiment, even when shock is transferred from outside the main fitting 20, the shock is not easily transferred through the holding fitting 24 to the glass seal 25.

In addition, according to the present embodiment, the shock mitigating portion 50 is arranged between the bottom portion 24b and the glass seal 25 inside the holding fitting 24. Therefore, even when shock is transferred to the bottom portion 24b of the holding fitting 24 from outside thereof, the shock is not easily transferred through the holding fitting 24 to the glass seal 25.

As a result of the foregoing, the A/F sensor 10 in which the transfer of shock from outside the holding fitting 24 the glass seal 25 is mitigated can be provided.

### Fourth Embodiment

According to the above-described third embodiment, an example in which the housing portion 60 that houses air (that is, gas) that serves as the shock mitigating portion is provided between the holding fitting 24 and the main fitting 20 is described.

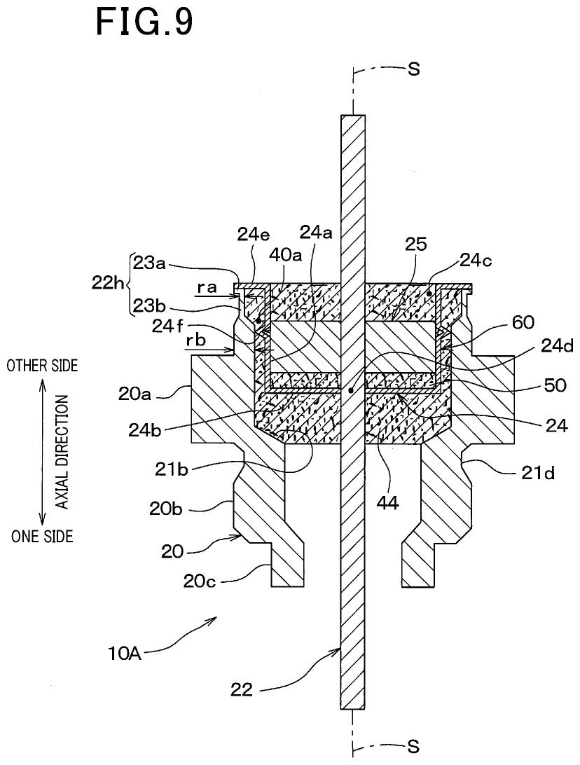

However, a present fourth embodiment in which a shock mitigating portion 44 that is made of talc is added between the holding fitting 24 and the main fitting 20 instead will be described with reference to FIG. 9.

The A/F sensor 10 according to the present embodiment is the A/F sensor 10 according to the above-described third embodiment in which the shock mitigating portion 44 is added. Configurations of the A/F sensor 10 other than the shock mitigating portion 44 are identical. Reference numbers in FIG. 9 that are the same as those in FIG. 8 indicate the same parts. Descriptions thereof are omitted.

The shock mitigating portion 44 is formed into a ring-shape centered on the axis S, between the cylindrical portion 20a of the main fitting 20 and the holding fitting 24. The shock mitigating portion 44 is formed so as to cover the glass seal 25 from the other side in the axial direction inside the holding fitting 24. The shock mitigating portion 44 is formed so as to cover the holding fitting 24 from one side in the axial direction.

The shock mitigating portion 44 is supported by the axial-direction other-side end portion 21b of the cylindrical portion 20b of the main fitting 20. The shock mitigating portion 44 can make shock that is applied from outside the main fitting 20 less easily transferred to the glass seal 25.

The shock mitigating portion 44 according to the present embodiment is made of a brittle material that has brittleness that is higher than that of the glass seal. The shock mitigating portion 44 is made of powdered talc that is hardened. A thermal conductivity tc1T of the shock mitigating portion 44 is less than the thermal conductivity tc2 (tc2>tc1T) of the main fitting 20 and less than the thermal conductivity tc3 (tc3>tc1T) of the holding fitting 24.

According to the present embodiment described above, the main fitting 20 and the holding fitting 24 house the shock mitigating portion 44 that mitigates shock being transferred from outside the main fitting 20 through the holding fitting 24 to the glass seal 25, between the main fitting 20 and the holding fitting 24.

Therefore, in a manner similar to that according to the above-described first embodiment, even when a small stone or the like strikes the outer side of the main fitting 20 and shock is transferred to the main fitting 20, the shock can be absorbed by the shock mitigating portion 44. Consequently, shock is not easily transferred from the main fitting 20 through the holding fitting 24 to the glass seal 25.

As a result of the foregoing, the A/F sensor 10 in which shock from outside the main fitting 20 being transferred to the glass seal 25 is mitigated can be provided.

The thermal conductivity tc1T of the shock mitigating portion 44 is less than the thermal conductivity tc2 (tc2>tc1T) of the main fitting 20 and less than the thermal conductivity tc3 (tc3>tc1T) of the holding fitting 24.

Therefore, even when water that is churned up from a puddle by a tire of an automobile splashes onto the main fitting 20 and the main fitting 20 is rapidly cooled, heat from the glass seal 25 being transferred through the holding fitting 24 to the main fitting 20 can be suppressed by the shock mitigating portion 44.

As a result, in a manner similar to that according to the above-described first embodiment, the glass seal 25 cracking as a result of rapid cooling of the main fitting 20 can be suppressed. That is, the glass seal cracking as a result of thermal shock and airtightness being compromised can be suppressed.

### Fifth Embodiment

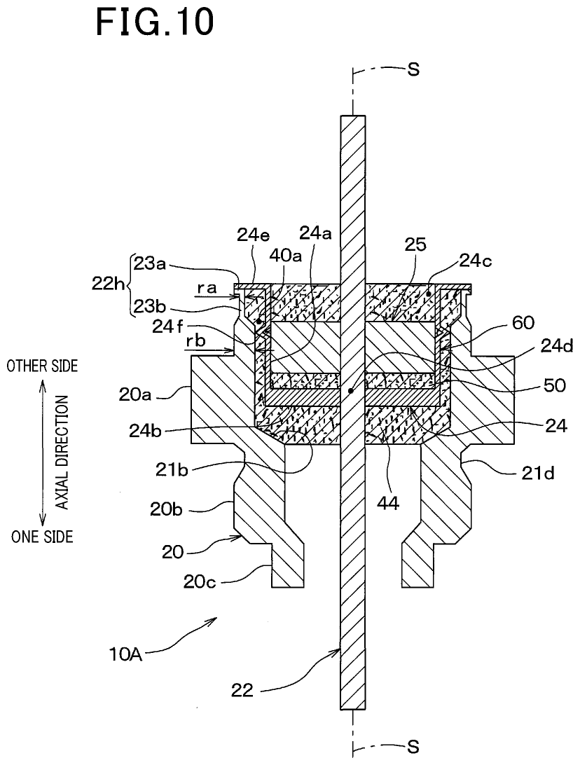

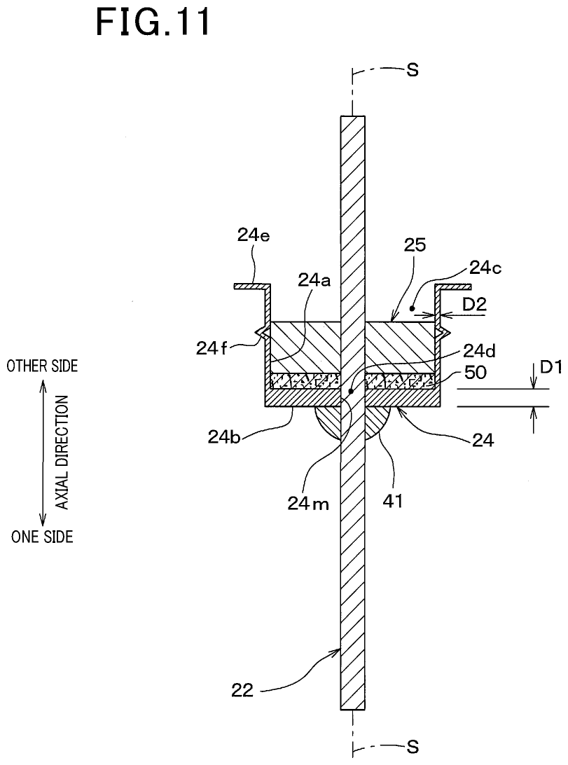

According to a present fifth embodiment, an example in which, according to the above-described fourth embodiment, a thickness dimension D1 of the bottom portion 24b of the holding fitting 24 is greater than a thickness dimension D2 of the side wall 24a will be described with reference to FIG. 10 and FIG. 11.

The A/F sensor 10 according to the present embodiment is the A/F sensor 10 according to the above-described fourth embodiment in which only a relationship between the thickness dimensions of the bottom portion 24b and the side wall 24a of the holding fitting 24 is modified. Other configurations are identical. Reference numbers in FIG. 10 that are the same as those in FIG. 9 indicate the same parts. Descriptions thereof are omitted.

As shown in FIG. 11, the thickness dimension D1 of the bottom portion 24b of the holding fitting 24 is greater than the thickness dimension D2 (D2<D1) of the side wall 24a.

Next, a manufacturing process for the sensor core 10A of the A/F sensor 10 according to the present embodiment will be described with reference to FIG. 5 and FIG. 11.

In the manufacturing process according to the present embodiment as well, in a manner similar to that according to the first embodiment, after the first process (step S100) is ended, in the subsequent second process (step S110), as shown in FIG. 11, the alumina slurry 41 is arranged so as to connect the outer side of the bottom portion 24b of the holding fitting 24 and the sensor element 22.

Then, in the subsequent third process (step S120), the sensor element 22, the holding fitting 24, the glass material, and the alumina slurry 41 that are assembled in this manner are placed in a high-temperature furnace, and the sensor element 22, the holding fitting 24, the glass material, and the alumina slurry 41 are heated.

At this time, the alumina slurry 41 is fired and a sintered body of alumina is formed. Therefore, the glass material is melted inside the holding fitting 24 in a state in which the sintered body determines the position of the sensor element 22 relative to the bottom portion 24b of the holding fitting 24.

Here, in the process in which the alumina slurry 41 is fired, the resin material that is contained in the alumina slurry 41 is in a molten state.

Here, if the thickness dimension D1 of the bottom portion 24b of the holding fitting 24 is equal to or less than the thickness dimension D2 of the side wall 24a, the resin material that is in the molten state may enter the interior of the holding fitting 24 through the through hole 24d in the bottom portion 24b of the holding fitting 24.

Here, when the resin material infiltrates between the sensor element 22 and the glass seal 25 inside the holding fitting 24, formation of the glass seal 25 is hindered as a result of the resin material, and airtightness between the sensor element 22 and the holding fitting 24 may be compromised.

In contrast, as shown in FIG. 11, the thickness dimension D1 of the bottom portion 24b of the holding fitting 24 according to the present embodiment is greater than the thickness dimension D2 (D2<D1) of the side wall 24a. Therefore, in the third process (step S120), the resin material that is in the molten state infiltrating the interior of the holding fitting 24 can be suppressed in advance.

Subsequently, in the fourth process (step S130), the sensor element 22, the holding fitting 24, and the glass seal 25 are housed inside the main fitting 20. In addition, the tip end portion of the flange portion 24e of the holding fitting 24 is joined to the end portion on the other side in the axial direction of the main fitting 20 by welding. In addition, the tip end portion of the rib 24f is joined to the inner circumferential surface of the main fitting 20 by welding.

As a result of the foregoing, the main fitting 20, the sensor element 22, the holding fitting 24, and the glass seal 25 are integrated and the sensor core 10A is completed.

According to the present embodiment described above, the main fitting 20 and the holding fitting 24 house the shock mitigating portion 44 that mitigates shock being transferred from outside the main fitting 20 through the holding fitting 24 to the glass seal 25, between the main fitting 20 and the holding fitting 24.

Therefore, in a manner similar to that according to the above-described first embodiment, even when shock is transferred from outside the main fitting 20, the shock is not easily transferred through the holding fitting 24 to the glass seal 25. As a result of the foregoing, the A/F sensor 10 in which shock from outside the main fitting 20 being transferred to the glass seal 25 is mitigated can be provided.

As described above, the thickness dimension D1 of the bottom portion 24b of the holding fitting 24 according to the present embodiment is greater than the thickness dimension D2 (D2<D1) of the side wall 24a. Therefore, in the process of forming the sintered body of alumina in the third process (step S120), infiltration of the resin material can be suppressed. That is, the resin material of the alumina slurry 41 that is in the molten state in accompaniment with heating of the alumina slurry 41 infiltrating between the glass material and the sensor element 22 through the through hole 24d of the bottom portion 24b of the holding fitting 24 can be suppressed in advance.

As a result of the foregoing, the resin material that is in the molten state compromising the airtightness between the holding fitting 24 and the sensor element 22 can be prevented in advance.

### Other Embodiments

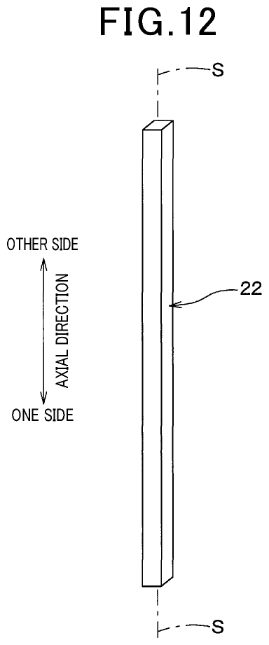

(1) According to the above-described first to fifth embodiments, an example in which the sensor element 22 that is formed into a circular cylindrical shape is used is described. However, instead, as shown in FIG. 12, the sensor element 22 that is formed into a rectangular columnar shape (or a cube) may be used.

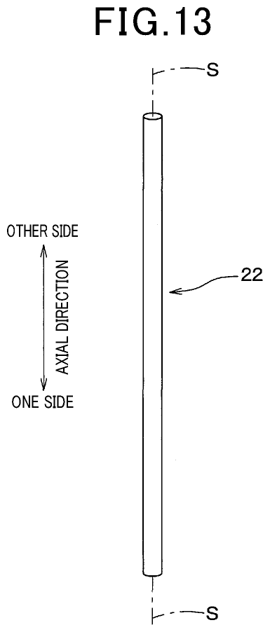

(2) According to the above-described first to fifth embodiments, an example in which the sensor element 22 that is formed into a circular cylindrical shape is used is described. However, instead, as shown in FIG. 13, the sensor element that is formed into a circular columnar shape may be used.

(3) According to the above-described first to fifth embodiments, an example in which the A/F sensor 10 that outputs the detection signal that indicates the ratio of the oxygen concentration in the gas to be measured and the oxygen concentration in the reference gas is used as the gas sensor is described.

However, instead, following gas sensors (a) and (b) may be used.

(a) A gas sensor that outputs a detection signal that indicates a ratio of a concentration of a detection-target gas in the gas to be measured and a concentration of the detection-target gas in the reference gas may be used, the detection-target gas in the gas to be measured being a gas (such as NOₓ) other than oxygen.

(b) A gas sensor that detects a concentration of a detection-target gas (such as the oxygen concentration) in the gas to be measured may be used.

(4) According to the above-described first to fifth embodiments, an example in which the gas sensor is arranged in the exhaust pipe 2 of the gasoline engine 1 for traveling of an automobile is described. However, instead, the gas sensor may be arranged in the exhaust pipe 2 of a diesel engine.

(5) According to the above-described first to fifth embodiments, an example in which the gas sensor is applied to an automobile is described. However, instead, the gas sensor may be applied to an apparatus other than the automobile (for example, a moving body such as a motorcycle or an airplane).

(6) According to the above-described fourth embodiment, an example in which the shock mitigating portion 44 is made of talc is described. However, instead, the shock mitigating portion 44 may be composed using of an inorganic material or an inorganic compound (such as vermiculite) other than talc.

Alternatively, the shock mitigating portion 44 may be made of a metal powder such as iron or titanium. In addition, the shock mitigating portion 44 may be made of a ceramic powder of which a base material is a metal material or inorganic material/inorganic compound.

Furthermore, in a manner similar to the shock mitigating portion 44, the shock mitigating portion 50 may be made of an inorganic material other than talc, a metal powder, or a ceramic powder.

The shock mitigating portion 44 such as this is preferably configured such that hardness is less than that of the main fitting 20 and the holding fitting 24.

(7) According to the above-described first to fifth embodiments, an example in which the holding fitting 24 and the main fitting 20 are joined by welding is described. However, instead, following (a) and (b) are also possible.

(a) The holding fitting 24 and the main fitting 20 are joined by brazing.

(b) A metal seal that is made of a metal material and holds the holding fitting 24 and the main fitting 20 by elastic force in a state in which the holding fitting 24 and the main fitting 20 are in close contact is used.

(8) According to the above-described first to fifth embodiments, an example in which argon that serves as an ambient gas is used when the glass material inside the holding fitting 24 is heated is described. However, instead, following (c) and (d) are possible.

(c) Non-oxidizing gas such as helium, carbon dioxide, or nitrogen may be used as the atmospheric gas.

(d) Reducing gas that serves as the ambient gas may be used. In this case, hydrogen, hydrocarbon gas, or the like can be used as the reducible gas.

(9) According to the above-described first to fifth embodiments, an example in which, when the glass material inside the holding fitting 24 is melted, the glass material inside the holding fitting 24 is heated in a state in which the interior of the holding fitting 24 and the periphery of the holding fitting 24 are filled with the ambient gas is described. However, instead, following (e) and (f) are possible.

(e) When the glass material inside the holding fitting 24 is melted, the glass material inside the holding fitting 24 may be heated in a state in which the sensor element 22, the glass material, and the holding fitting 24 are housed inside a high-temperature furnace of which an interior is in a vacuum state.

(f) The glass material inside the holding fitting 24 may be heated in the atmosphere. In this case, when oxides are formed on the surface of the holding fitting 24 as a result of an oxidation reaction progressing, the oxides are preferably removed from the surface of the holding fitting 24 after formation of the glass seal 25 inside the holding fitting 24.

(10) According to the above-described first to fifth embodiments, an example in which the single-layer glass seal 25 is used to seal between the holding fitting 24 and the sensor electrode 22 is described. However, instead, the glass seal 25 that is configured by a plurality of layers of glass may be used to seal between the holding fitting 24 and the sensor element 22.

(11) According to the above-described first to fifth embodiments, an example in which the holding fitting 24 and the main fitting 20 are welded after the glass seal 25 is formed inside the holding fitting 24 is described. However, instead, the glass seal 25 may be formed inside the holding fitting 24 after the holding fitting 24 and the main fitting 20 are welded.

(12) According to the above-described first to fifth embodiments, an example in which the coefficient of linear expansion CTE2 of the holding fitting 24 is less than the coefficient of linear expansion of the main fitting 20 is described. However, this is not limited thereto. The coefficient of linear expansion CTE2 of the holding fitting 24 may be greater than the coefficient of linear expansion CTE1 of the main fitting 20.

For example, a ferritic stainless steel, such as SUS430, or the like may be used as the holding fitting 24, and alumina, Kovar or the like may be used as the main fitting 20.

(13) According to the above-described first to fifth embodiments, an example in which the alumina slurry is used as a slurry for determining the position of the sensor element 22 relative to the bottom portion 24b of the holding fitting 24 is described.

However, instead, a slurry that contains a powder (or granules) of an inorganic substance other than alumina may be used as the slurry for determining the position of the sensor element 22 relative to the bottom portion 24b of the holding fitting 24. The inorganic substance that is used in the slurry may be a metal or a non-metal. That is, the position of the sensor element 22 relative to the bottom portion 24b of the holding fitting 24 may be determined by a sintered body of an inorganic substance other than alumina.

(14) According to the above-described first to fifth embodiments, an example in which the main fitting 20 and the holding fitting 24 configure the housing portion 60 is described. However, instead, a following is possible.

Instead of the foregoing, a metal member may be arranged between the main fitting 20 and the holding fitting 24, and the housing portion 60 may be configured between the main fitting 20 and the holding fitting 24. Alternatively, the housing portion 60 may be configured between the holding fitting 24 and the metal member.

(15) According to the above-described first to fifth embodiments, an example in which a main fitting that has a circular cylindrical shape is used as the main fitting 20 is described. However, instead, a main fitting that has a rectangular cylindrical shape may be used as the main fitting 20.

(16) According to the above-described first to fifth embodiments, an example in which a holding fitting that has a cylindrical shape is used as the holding fitting 24 is described. However, instead, a holding fitting that has a rectangular cylindrical shape may be used as the holding fitting 24.

(17) According to the above-described first to fifth embodiments, an example in which the axis of the holding fitting 24 coincides with the axis S of the main fitting 20 is described. However, instead, the holding fitting 24 may be arranged such that the axis of the holding fitting 24 is shifted relative to the axis S of the main fitting 20.

Alternatively, the holding fitting 24 may be arranged such that the axis of the holding fitting 24 intersects the axis S of the main fitting 20.

(18) According to the above-described first to fifth embodiments, an example in which a bottom portion that is formed so as to spread in the radial direction centered on the axis S is used as the bottom portion 24b of the holding member 24 is described. However, instead, (g) or (h) may be possible.

(g) The bottom portion 24b of the holding fitting 24 may be formed so as to advance towards one side in the axial direction, towards a center side in the radial direction from the outer side in the radial direction centered on the axis S.

(h) The bottom portion 24b of the holding fitting 24 may be formed so as to approach towards the other side in the axial direction, towards the center side in the radial direction from the outer side in the radial direction centered on the axis S.

(19) Here, the present disclosure is not limited to the above-described embodiments. Modifications can be made as appropriate. In addition, an element that configures an embodiment according to the above-described embodiments is not necessarily a requisite unless particularly specified as being a requisite, clearly considered a requisite in principle, or the like.

Furthermore, in cases in which a numeric value, such as quantity, numeric value, amount, or range, of a constituent element of an embodiment is stated according to the above-described embodiments, the numeric value is not limited to the specific number unless particularly specified as being a requisite, clearly limited to the specific number in principle, or the like.

Moreover, in cases in which a shape, a positional relationship, or the like of a constituent element or the like is stated according to the above-described embodiments, the constituent element or the like is not limited to the shape, the positional relationship, or the like unless particularly specified, limited to a specific shape, positional relationship, or the like in principle.

### CONCLUSION

According to a first aspect that is described in a portion or the entirety of the above-described first to fifth embodiments and other embodiments, the gas sensor includes a housing that has a cylindrical shape.

The gas sensor includes a holding portion that is arranged inside the housing and has a cylindrical shape that has a through hole that passes through in an axial direction, when a direction in which an axis of the housing extends is the axial direction.

The gas sensor includes a sensor element that is formed so as to extend in the axial direction in a state in which the sensor element passes through the through hole in the holding portion and detects a gas to be measured on one side in the axial direction, and a glass seal that is arranged inside the holding portion, is made of a glass material, and seals between the sensor element and the holding portion.

A shock mitigating portion that mitigates shock being transferred from outside the housing through the holding portion to the glass seal is housed between the housing and the holding portion.

According to a second aspect, in the gas sensor, the holding portion has a cylindrical shape that is provided with the bottom portion on one side in the axial direction and communicates with another side in the axial direction. The through hole is provided in the bottom portion. As a result, the glass seal can be easily held.

According to a third aspect, in the gas sensor, a thermal conductivity of the shock mitigating portion is less than a thermal conductivity of the housing, and the thermal conductivity of the shock mitigating portion is less than a thermal conductivity of the holding portion.

As a result, for example, even when water comes into contact with an outer side of the housing and the housing is rapidly cooled, the shock mitigating portion can suppress heat rapidly moving from the glass seal side to the housing side. Therefore, heat being rapidly released from the glass seal, and the glass seal contracting and breaking can be suppressed in advance.

That is, the glass seal breaking as a result of thermal shock applied from outside the housing can be prevented in advance.

According to a fourth aspect, in the gas sensor, the shock mitigating portion is made of air or talc.

According to a fifth aspect, in the gas sensor, a housing portion that houses the shock mitigating portion is configured between the housing and the holding portion. The holding portion is provided with a protruding portion that protrudes towards the housing side. The housing portion is configured by the housing and the holding portion by a tip end side of the protruding portion being joined to the housing.

According to a sixth aspect, in the gas sensor, when the protruding portion is a first protruding portion, the holding portion is provided with a second protruding portion that is arranged in the axial direction relative to the first protruding portion and protrudes towards the housing side.

The housing portion is configured by a tip end side of the first protruding portion being joined to the housing and a tip end side of the second protruding portion being joined to the housing.

As a result, the housing and the holding portion can be firmly fixed. Therefore, the housing portion can be more reliably ensured.

According to a seventh aspect, in the gas sensor, when the shock mitigating portion is a first shock mitigating portion, a second shock mitigating portion that is arranged on one side in the axial direction of the holding portion relative to the glass seal and mitigates shock being transferred from one side in the axial direction relative to the holding portion to the glass seal is provided.

As a result, shock that is applied from the bottom portion side of the holding portion being transferred to the glass seal can be suppressed.

According to an eighth aspect, in the glass sensor, the second shock mitigating portion is a brittle portion that is more brittle than the glass seal.

According to a ninth aspect, in the glass sensor, the sensor element has a cylindrical shape or a columnar shape.

According to a tenth aspect, in the glass sensor, the glass seal is configured to be a single layer.

According to an eleventh aspect, in the glass sensor, a coefficient of linear expansion of the housing is greater than a coefficient of linear expansion of the holding portion, and the coefficient of linear expansion of the holding portion is greater than a coefficient of linear expansion of the glass seal.

As a result, the holding portion can suppress force being applied from the housing to the glass seal side as a result of thermal expansion of the housing.

According to a twelfth aspect, in the gas sensor, a difference in coefficient of expansion that is a difference between the coefficient of linear expansion of the housing and the coefficient of linear expansion of the holding portion is equal to or less than 6×10⁻⁶/° C.

According to a thirteenth aspect, in the gas sensor, the housing, the holding portion, the sensor element, and the glass seal are applied to a vehicle, and an outer wall of the housing is exposed outside the vehicle.

According to a fourteenth aspect, a manufacturing method for a gas sensor includes preparing a housing that has a cylindrical shape, a holding portion that has a cylindrical shape, and a sensor element.

The manufacturing method for a gas sensor includes forming, inside the holding portion, a glass seal that seals between the holding portion and the sensor element in a state in which the sensor element passes through a through hole in the holding portion.

The manufacturing method for a gas sensor includes arranging the holding portion inside the housing, and joining the housing and the holding portion to configure, by the housing and the holding portion, a housing portion for housing a shock mitigating portion between the housing and the holding portion.

According to a fifteenth aspect, in the manufacturing method for a gas sensor, the holding portion is made of a metal, and the step of forming the glass seal between the holding portion and the sensor element includes housing a glass material inside the holding portion in a state in which the sensor element passes through the through hole.

The manufacturing method for a gas sensor includes heating the glass material in a state in which an ambient gas for suppressing an oxidation reaction of the holding portion fills a periphery of the holding portion; and melting the glass material.

The manufacturing method for a gas sensor includes solidifying the glass material after the glass material is melted, and forming the glass seal between the holding portion and the sensor element.

According to a sixteenth aspect, in the manufacturing method for a gas sensor, the step of the glass seal between the holding portion and the sensor element includes: preparing a slurry that contains an inorganic substance and a resin and has fluidity; and arranging the slurry so as to connect the holding portion and the sensor element on an outer side of the holding portion in a state in which the sensor element passes through the through hole in the holding portion.

In the manufacturing method for a gas sensor, the step of forming the glass seal between the holding portion and the sensor element includes, when the glass material that is housed inside the holding portion and the slurry are heated after the slurry is arranged, firing the slurry to form a sintered body of the inorganic substance, and melting the glass material inside the holding portion in a state in which the sintered body determines a position of the sensor element relative to the holding portion.

The manufacturing method for a gas sensor includes solidifying the molten glass material to form the glass seal.

As a result, the glass seal can be formed in a state in which the position of the sensor element relative to the holding portion is accurately held.

According to a seventeenth aspect, in the manufacturing method for a gas sensor, the holding portion includes a side wall that has a cylindrical shape and a bottom portion in which the through hole is formed.

As a result of a thickness dimension of the bottom portion being greater than a thickness dimension of the side wall, when the slurry is heated, the resin that is contained in the slurry infiltrating an interior of the holding portion through the through hole in a molten state is suppressed.

Consequently, the resin infiltrating the interior of the holding portion and airtightness between the holding portion and the housing being compromised can be suppressed in advance.

What is claimed is:

1. A manufacturing method for a gas sensor comprising:
preparing a housing that has a cylindrical shape, a holding portion that has a cylindrical shape, and a sensor element;
forming, inside the holding portion, a glass seal that seals between the holding portion and the sensor element in a state in which the sensor element passes through a through hole in the holding portion; and
arranging the holding portion inside the housing, and joining the housing and the holding portion to configure, by the housing and the holding portion, a housing portion for housing a shock mitigating portion between the housing and the holding portion, wherein:
the holding portion is made of a metal;
the step of forming the glass seal between the holding portion and the sensor element includes
placing a glass material inside the holding portion in a state in which the sensor element passes through the through hole,
heating the glass material in a state in which an ambient gas for suppressing an oxidation reaction of the holding portion fills a periphery of the holding portion, and melting the glass material, and
after the glass material is melted, solidifying the glass material to form the glass seal between the holding portion and the sensor element;
the holding portion includes a side wall that is formed into a cylindrical shape and a bottom portion in which the through hole is formed; and
the step of forming the glass seal between the holding portion and the sensor element includes
preparing a slurry that contains an inorganic substance and a resin and has fluidity, and arranging the slurry so as to connect the bottom portion and the sensor element on an outer side of the holding portion in a state in which the sensor element passes through the through hole in the bottom portion of the holding portion,
when the glass material that is housed inside the holding portion and the slurry are heated after the slurry is arranged, firing the slurry to form a sintered body of the inorganic substance, and melting the glass material inside the holding portion in a state in which the sintered body determines a position of the sensor element relative to the holding portion, and
solidifying the molten glass material to form the glass seal.
